(19) United States
(12) Patent Application Publication
(10) Pub. No.: US 2020/0311251 A1
(43) Pub. Date: Oct. 1, 2020

(54) PASSWORD MANAGEMENT TOOL EMPLOYING NEURAL NETWORKS

(71) Applicant: Deep Valley Labs, Inc., San Jose, CA (US)

(72) Inventors: Jay Underwood, Fremont, CA (US); Joseph Han, Redwood City, CA (US)

(21) Appl. No.: 16/370,715

(22) Filed: Mar. 29, 2019

(51) Int. Cl. G06F 21/46; G06N 3/08

(52) U.S. Cl. CPC G06F 21/46; G06N 3/08

(57) ABSTRACT

A password management method employs one or more items from multiple categories of available information to enable user access to a secure resource. A user-specific strong password is generated. A neural network is trained to recall the strong password from the one or more items. Examples of such items may include a combination of letters, numbers, characters, and/or symbols, or pictures, in one category; information related to hardware used to access the secure resource, in another category; and a user's biometric information, in yet another category. Items may come from other categories as well. The neural network may reside on the hardware used to access the secure resource, or may reside at the secure resource itself, or in the cloud.

### FIELD OF THE INVENTION

Aspects of the present invention relate to user authentication. More particularly, aspects of the invention relate to user authentication employing neural networks to store strong passwords. Still more particularly, aspects of the invention relate to a password manager employing neural networks in association with one or more readily available pieces of information to ensure secure access to a resource, which in one merely exemplary aspect may be a web site.

### BACKGROUND OF THE INVENTION

Various types of password or passphrase-based, environmentally-based, and biometric-based user authentication are known. Each has its drawbacks, taken alone, for reasons well known to ordinarily skilled artisans.

### SUMMARY OF THE INVENTION

In one aspect, when a user first seeks access to a resource, the user may generate and then input a username and password, or other type of authentication. A strong (hard to guess or replicate) password is generated. A neural network is trained to replicate the strong password in response to user-provided information. In one aspect, that information may be selected from a category of information that is password-based. In another aspect, the user-provided information may be selected from a category of information that is environmentally-based. In yet another aspect, the user-provided information may be selected from a category of information that is biometric-based. In still other aspects, the user-provided information may be selected from other categories of information.

The user-provided information need not be the same as the user authentication information used in generating the strong password. Weights generated in response to the training of the neural network are retained and are used for subsequent user access. In one aspect, different sets of weights may be generated in different training sessions to permit user access in different environments. In various aspects, client-side and server-side implementations may be provided.

### BRIEF DESCRIPTION OF THE DRAWINGS

Aspects of the present invention now will be described in detail with reference to embodiments as depicted in the accompanying drawings, in which:

FIG. 1 is a high level diagram of a neural network according to an embodiment;

FIG. 2 is a flow chart depicting training of a neural network according to an embodiment;

FIG. 3 is a flow chart depicting retraining of a neural network according to an embodiment;

FIG. 4 is a very high level diagram depicting input devices which access resources according to embodiments.

### DETAILED DESCRIPTION OF EMBODIMENTS

Embodiments of the invention provide a password management method comprising:

providing a first item of information;

generating a strong password;

providing said strong password and the first item to a neural network; and

training said neural network to generate said strong password from said first item.

Other embodiments provide a password management method which uses additional items of information. There may not be a theoretical limit to how many items of information may be used. In one aspect, to balance security and practicality, two or more items of information may be used. In a further aspect, information about who a user is; what the user knows; and what the user has may be inputs to the neural network to generate the strong password.

The strong password may be generated in various ways known to ordinarily skilled artisans. The user does not use the strong password to gain access, but instead uses the one or more items of information. In an embodiment, the strong password may be generated from random selection of various characters based on pre-defined rules, for example, minimum (and maybe a maximum) length, some number of lower case letters, some number of upper case letters, some number of numbers, some number of symbols, etc. In an embodiment, the characters may be accessible directly from a keyboard, but according to other aspects, the characters may be generated from ASCII or other codes. In one aspect, the symbols may be emojis or other such generated characters. The strong password could be constituted by numerous other types of things that a user could input, including for example pictures or images in various formats, sounds in various formats, or even GIFs or videos in various formats.

As will be discussed, there are various kinds of neural networks. In general, neural networks constitute a mechanism for a type of deep learning or machine learning (sometimes referred to as artificial intelligence), in which for example a processor, computer, or processing or computing system learns to perform a task by analyzing samples. In general, a neural network learns by sifting data repeatedly, identifying relationships from which to build mathematical models. The neural network will correct these models, refining them until the desired output is achieved.

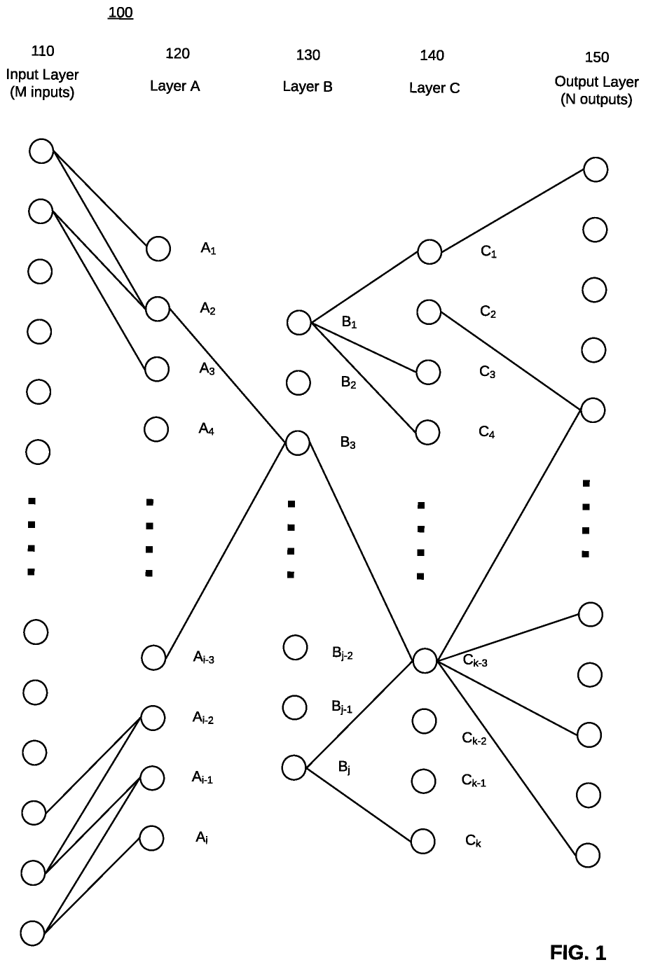

In an embodiment, the neural network is a multi-layer (deep) neural network. However, the invention is not so limited. Other types of neural networks, such as recurrent neural networks, long short-term memory neural networks, or spiking neural networks may be used. Generally, such networks are known to ordinarily skilled artisans. For ease of reference, a few relevant details are provided as follows, with reference to FIG. 1.

In multi-layer neural networks, each node in a given layer will have a connection to all of the nodes in the next layer. Nodes may be input nodes, such as the M input nodes in layer 110, which receive data from outside the network. In an embodiment, input nodes will receive the first and optional additional items of information. Nodes may be output nodes, such as the N output nodes in layer 150, which provide results. In an embodiment, each output node in layer 150 provides one character or symbol for the strong password. Nodes also will be hidden nodes, which may be in one or more layers, such as layers 120, 130, and 140, which can perform modifications on data as it goes through the neural network in order to generate the desired output at layer 150. Each connection between nodes will have a modifiable weight that is configured during initialization so that the output consistently will be the same strong password when provided the same inputs.

FIG. 1 shows three layers of hidden nodes, but such nodes may be a single layer in the neural network. Any nodes in one layer may be connected to any nodes in adjacent layers. A few such connections are shown by way of example.

For a given strong password, depending on a number of devices from which a user may desire to access a particular resource, different initialization may be necessary to train the neural network, yielding a different set of weights. As a result, the neural network will need different weights among the connections in order to “learn” the strong password for a given set of inputs.

In an embodiment, the process by which the neural network “learns” the strong password is referred to as backpropagation, which refers to backward propagation of errors through the network. Generally, in this process, the neural network will generate a first result and will compare it to the strong password. If the comparison fails, the neural network will alter one or more of its weights and will attempt the comparison again. The size of the error after the second attempt, compared to the size of the error after the first attempt, will inform the neural network as to the direction in which the next correction should go. By monitoring the magnitude and direction of the error after each iteration, the neural network is able to recall the strong password consistently.

The foregoing discussion of backpropagation is not intended to be exhaustive as to neural network techniques. In various embodiments, neural networks may employ feed forward or other processes for learning.

One relevant aspect is that the neural network will be the item which verifies access. As a result, if any portion of the information used to replicate the password—any of the user-provided information, or the weights of the neural network—is stolen, there is still an extremely low likelihood that the password could be replicated without the missing information. All of the information that a user would provide still would be necessary so that the neural network could replicate the strong password and thereby verify access.

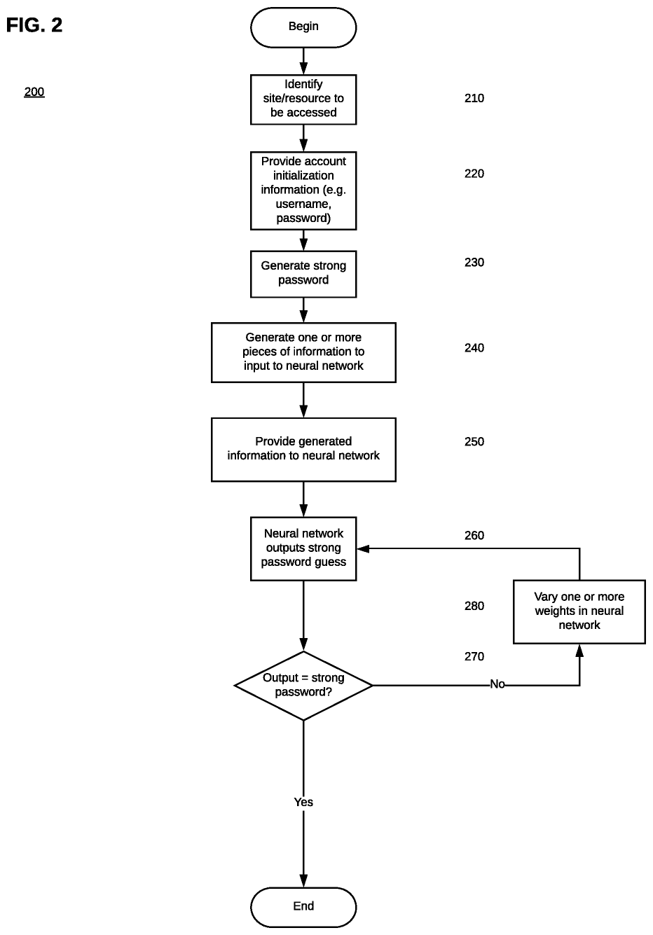

Aspects of the invention now will be described with reference to FIG. 2, which shows, at a high level, an operational flow 200 resulting in training of a neural network to recognize user inputs in order to verify user access to a resource.

At 210, a user navigates to a resource to be accessed. In one aspect, the user is initializing access to the resource (e.g. creating an account for access to the resource). In another aspect, an embodiment of the invention is available to the user for the first time, resulting effectively in re-initialization.

At 220, the user provides a username and user password. If the user is creating an account, the username may be a name, an email address, or something else. Since a strong password is to be generated, there may be minimal requirements for the user password the user inputs. The user password, along with the username or email address, will be used by the neural network to output the strong password, which the user does not have to remember.

At 230, the strong password is generated. Various aspects of strong password content and generation were discussed above. As ordinarily skilled artisans will appreciate, there are various known criteria for a password to be strong. The lower the degree of “hackability” of the password, the stronger it is. Hackability can be a function of password length, selected characters, selected combinations of characters, or other criteria which will be known to ordinarily skilled artisans. Many strong password generators will generate a lengthy random (pseudo-random) combination of upper and lower case letters, numbers, and/or symbols as the strong password. Other strong password generators may generate a series of random words, perhaps with one or more symbols between consecutive words.

At 240, in accordance with one aspect, a piece of information is generated or provided. The user will use this piece of information to access the resource via the neural network. In one aspect, the piece of information may be from a category of information that includes something that the user knows. This may be a word, a series of words, or a phrase that the user can remember easily. In one embodiment, this is the user password that was provided in 220.

In another embodiment, the piece of information may be a picture or other symbol that the user selects from a plurality of such pictures or symbols. For example, the user may select a picture of a baseball, or a flower, or a person, or some other picture, as the piece of information. In an embodiment, the user may provide multiple pieces of information from this category of things that the user knows.

In another embodiment, the piece of information may be from a category of information that includes something that the user has, for example, a piece of information from the hardware from which the user is accessing the resource. This type of information is useful because the user presumably will access the resource regularly from that piece of hardware, and so will not change. The piece of information may include, for example, an electronic serial number or other identifying number for the hardware. If the user will be accessing the resource consistently from a particular location, the piece of information may be a static IP address. Bearing in mind that the user may desire to access the resource from different pieces of hardware or from different locations, it may be desirable to select, as this piece of information, something that does not vary, so that the user uses the same piece of information consistently to access the resource. In an embodiment, the user may provide multiple pieces of information from this category of things that the user has.

In another embodiment, the piece of information may be from a category of information that includes something that the user is—a fingerprint, a retinal scan, facial recognition from image or depth sensors, or the like. In an embodiment, the user may provide multiple pieces of information from this category of things that the user is.

The foregoing categories of information are intended to be illustrative, not exhaustive. There may be different types of information that a user knows; or that a user has; or that a user is. There may be still different types of information, not specifically enumerated here, that a user may enter in order for the neural network to recall the strong password. Training of the neural network may be varied accordingly.

According to various embodiments, the user may provide combinations of the aforementioned categories of information.

At 250, the generated information is provided to the neural network. As far as 240 and 250 are concerned, the neural network may receive the information as the user either selects it or otherwise provides it. According to different embodiments, one or more of the above-referenced types of information, or even all three types of information, all may be used as inputs. According to other embodiments, additional pieces of information, of the same or different types, also may be used.

At 260, armed with the strong password as a desired output and the one or more pieces of information as input(s), the neural network sets its weights and generates an output from the input(s). At 270, the output is compared with the strong password. If the comparison is unfavorable, then at 280, one or more weights in the neural network will be varied, and the comparison is tried again. The loop of 260 to 280 is repeated until the comparison is favorable.

In the course of correcting the weights at the various nodes in the neural network, the comparison results may be monitored to see if each guess is closer to or farther away from the strong password than is the preceding guess. Using the direction of the series of guesses helps educate, or train the neural network to make better guesses, and to progress toward generating the strong password.

Once the neural network itself is able to generate the strong password from the one or more pieces of information, the user may use the same piece(s) of information to gain access to the resource, without having to remember the strong password.

Where more than one piece of information is input to the neural network, the order of input of those pieces of information in FIG. 2 does not matter. The system could request or retrieve the information in any order. The system also could request or retrieve two or more of the pieces of information at the same time or nearly the same time. For example, while a user is inputting his/her word or phrase, the system could be doing facial or other physical characteristic recognition on the user. As other examples, in response to a user inputting his/her username, the hardware into which the user is inputting the information may retrieve the hardware serial number, or the static IP address, or other information related to the category of information that a user has.

A password manager as just described in accordance with embodiments has the following advantages:
1) Even if an unauthorized person were to get all the weights of the neural network, the input required to recall the strong password would be missing. Furthermore, the use of neural network weights to store the strong password is not vulnerable to retrieval compared with traditional password storage techniques such as encryption or hashing.
2) In embodiments involving more than one piece of information, even if an unauthorized person were to get one piece of the user's information, such as the password/passphrase, or even the hardware ID (assuming that the unauthorized person were to be able to try to access the resource from the user's own device), the remaining piece of information, such as the biometric information, still would be lacking. The unauthorized person still would lack the input that the neural network is expecting, so there still would not be a match.

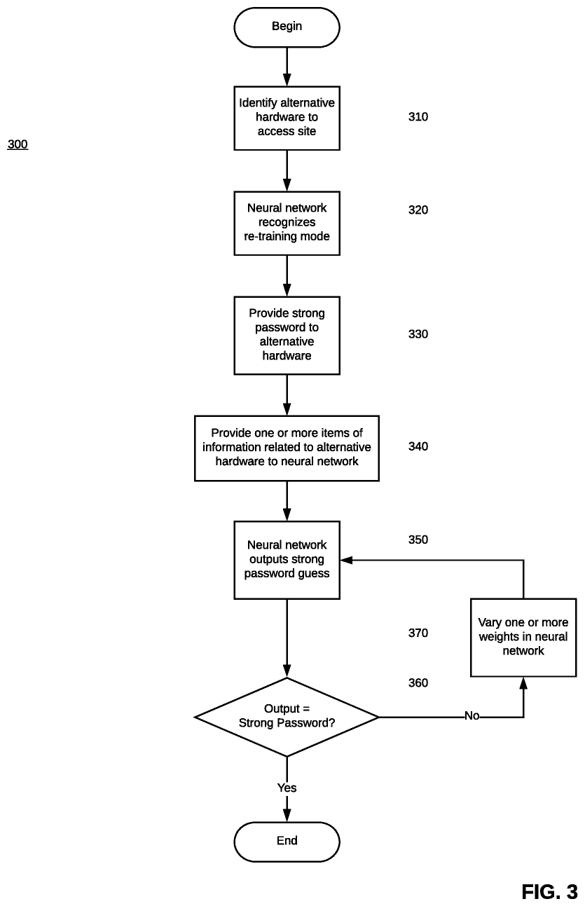

In accordance with an embodiment, a user may be accessing a resource from a mobile device, and may wish to access the resource from his/her desktop, or vice versa. If the user tries to access the resource with the different piece of hardware, the neural network may not generate the strong password from the one or more inputs, because one of the inputs may be different (if based on the hardware being used to access the resource). In that event, it may be desirable for the user to be able to train the neural network to recognize access from the new device. This training will result in a new set of weights for the nodes in the neural network. FIG. 3 depicts a re-training sequence according to an embodiment.

In FIG. 3, at 310, the user determines that s/he would like to recall the strong password through a different piece of hardware in order to access a resource. At 320, a re-training, or a further training mode is recognized. For a neural network resident remotely, for example, at the resource, there will be re-training. For a neural network residing on the different piece of hardware, there will be training. In either event, at 330, through an exchange mechanism the strong password is provided to the alternative hardware.

For training of a neural network on board the different piece of hardware, flow will proceed as in FIG. 2, because this neural network will be different. For re-training of a neural network, ordinarily skilled artisans will appreciate that there are numerous ways in which a neural network can recognize that it is being “re-trained,” whether to permit user access from a different environment, or whether to permit user access using different pieces of information (for example, when a user chooses to change his/her user password). By way of non-limiting example, one possibility is that the user transmits the strong password, via a QR code, near field communication (NFC), Bluetooth™, or other communication medium, to a new piece of hardware from which the user wishes to access the resource. This transmission could signal the application that retraining is necessary.

At 340, one or more items of information are provided to the neural network. The item(s) provided may be the same as with the previous hardware, or may be different. Irrespective of whether the information provided is different, at this point, by virtue of having received the strong password from a different piece of hardware, the neural network, has recognized that further training is involved. At 350, armed with the strong password as a desired output and one or more items of information as inputs, the neural network sets its weights and generates an output from the three inputs. At 360, the output is compared with the strong password. If the comparison is unfavorable, then at 370, one or more weights in the neural network will be varied, and the comparison is tried again. The loop of 350 to 370 is repeated until the comparison is favorable.

In either of the just-mentioned scenarios (training a new neural network, or re-training an existing one), the application can verify that different item(s) of information may be used to verify user access. For example, where the hardware ID (specific to a piece of hardware being used to access the application) represents the user's environment, the neural network could attempt access using that ID, either alone or, depending on the embodiment, along with one nor more other pieces of information, and recognize that denial of access means that retraining may be necessary. The user then may be invited to provide the same username and password used to create the account in the first instance.

Using a QR code or other communication with the new environment to provide the strong password may be considered less secure, because the communication could be stolen or intercepted. However, it should be remembered that just having the strong password does not enable access to the application.

Retraining a neural network need not be limited to a change of hardware used to access the resource. Password changing practices may motivate altering of any of the one or more pieces of information in order to change the strong password. Of course, the user would have to be able to access the resource before being invited/instructed to change his/her strong password.

In the usual flow of re-training a neural network as part of the password management process, information from the first category—for example, the easily-remembered word or phrase—will tend to be invariant. Information from the third category—for example, biometric information—also will tend to be invariant. For example, if the strong password is generated using a fingerprint, or facial recognition, the information provided to the neural network being accessed may be the same (i.e. the same fingerprint or facial recognition, respectively). If the user wants to use a different type of biometric information, it will be necessary to retrain the neural network to recognize that different type of biometric information as part of the trio of information the user provides in order to gain access to the resource. This may be done as part of a password-changing exercise, as discussed previously.

According to embodiments, for the first item of information, an easily-remembered word, number, date, name, or phrase can make it easier for a user to log in to a resource without having to remember or write down/record something more complicated or otherwise more difficult to remember.

Hardware environment information may include device identification information, which tends to be invariant. Such environment information also may include wired/wireless network address information, which can be either variant or invariant, depending on the network architecture and the like. Software environment information could include software license numbers (for example, for the operating system running on the hardware), or a software token. Physical environment information may include information about physical (e.g. GPS) location and/or information about aspects of weather and/or time of day. Such information has more of a tendency to be fluid, particularly when the hardware through which the user is accessing a resource is portable. Biometric information may include information about various physical attributes of a user.

In one aspect, the referenced information that a user has could be something related to the user's environment. The following is a non-exclusive list of environmental information which may be used in accordance with embodiments. This list is intended to provide examples, and not to be exhaustive. Ordinarily skilled artisans will recognize that other types of environmental information may be employed as appropriate:
Hardware ID
   serial number
   international mobile equipment identity (IMEI) number
   universally unique identifier (UUID) (some versions of UUID are not hardware-specific)
   globally unique identifier (GUID) (some versions of GUID are not hardware-specific)
   uniform resource name (URN)
Software token
Software license number (for example, of the operating system on which the hardware is running)
Separately-generated code used in two-factor authentication
Ethernet address
WiFi address
MAC address
Time of day/time zone
GPS coordinates

Some of the items above, such as Ethernet addresses, WiFi addresses, and GPS coordinates, can vary as a function of physical location. In such circumstances, it may be desirable to provide an allowable range for such items, enabling a user, for example, to access the application or resource from different locations in a home or office. In the case of GPS coordinates, a wider range that allows for more widespread geographic access may be desirable. For example, beyond the range of a building or a complex, there might be a 10 mile, 100 mile, or 1000 mile radius, for example. Similarly, for time zone, a user may restrict to a single time zone, or to adjacent or multiple time zones, as desired. For time of day, a user may restrict to a short span of hours, or a longer span, as desired. MAC addresses tend to be relatively invariant, except in certain circumstances which ordinarily skilled artisans understand well.

In an embodiment, some combination of the foregoing items may be employed. For example, one form of universal unique identifier (UUID) is a 128-bit number that is generated from a MAC address of a piece of hardware, and a time of day. In such a circumstance, it may be desirable to recognize the UUID when the user is attempting access at particular times of day, or during particular ranges of times, or from a particular MAC address, or ranges of MAC addresses. In such circumstances, an attempt by someone else to use the same hardware from a sufficiently different location, or outside the allowable range of times, will fail. Another form of UUID is a 128-bit number generated from a secure random number generator. In one aspect, the generated number may vary as a function of the hardware on which it is generated. In another aspect, a globally unique identifier (GUID) may be used.

In an embodiment, when the user is setting up his/her account on the application, the application may ask for a particular piece of information in the category of information that a user has. As an alternative, the application may give the user certain options which may include some or all of the foregoing options.

As noted earlier, one category of information which the user may employ is biometric. The following is a non-exclusive list of biometric information which may be used in accordance with aspects of the invention. This list is intended to provide examples, and not to be exhaustive. Ordinarily skilled artisans will recognize that other types of human physiological characteristics may be employed as appropriate:
Fingerprint matching
Hand geometry matching
Palm vein recognition
Finger vein recognition
Face ID
Retina recognition
Iris recognition
Eye vein recognition
Other physical characteristics, including heartbeat, salination of skin, skin pH, oxygen content in blood, or body temperature
Manner of movement (gait)
Manner of typing (keystroke speed or keystroke pressure)
Voice/Speech recognition

One or more of the just-enumerated characteristics may vary depending on a user's condition and/or geographic location (for example, current or recent exertion versus remaining stationary; presence at altitude and effect on bodily function and/or status; presence in different weather conditions and effect on bodily function and/or status).

In an embodiment, when the user is setting up his/her account on the application, the application may ask for a particular piece of information in the category of information that a user is. As an alternative, the application may give the user certain options which may include some or all of the foregoing options. In an embodiment, the options presented may be a function of available equipment (as connected to the device through which the user is setting up his/her account) to receive the biometric information.

In an embodiment, a neural network is resident on the piece of hardware through which the user accesses the secure online resource. As a user seeks access to the secure online resource through different pieces of hardware, different neural networks will be trained.

In another embodiment, the neural network may be resident at the secure resource, or in the cloud. In that event, when a user changes from one piece of hardware to another to access the resource, the retraining of the neural network may result in storage of a different set of weights for the nodes in the neural network. When a user attempts to access the application through a piece of hardware, the input information may be run through the neural network with each of the sets of weights to determine which set of weights yields the strong password. In an embodiment, instead of storing different sets of weights, the resource may store multiple neural networks, one for each piece of hardware that the user uses to access the application.

Ordinarily skilled artisans will appreciate that the process for a single user may be replicated for all users seeking to access the resource. Where the neural network is located in the hardware being used, there may be a different neural network for each user/hardware combination. Where the neural network is located in the cloud, there may be a different set of weights for each user, and a single neural network; there may be a different neural network for each user; or there may be groups of users for a given neural network, and appropriate sets of weights for those users and that neural network.

In the foregoing description, it may be possible to interpret certain steps as occurring in a particular sequence. However, ordinarily skilled artisans will appreciate that this is not necessarily the case. By way of nonlimiting example, the user may provide the one or more items of information, whether as part of training the neural network, or as part of accessing the online resource after training, in any sequence. During training, the user may provide the one or more items of information before inputting a username and password. The strong password may be pre-generated and assigned to a user when the user creates his/her account at the resource.

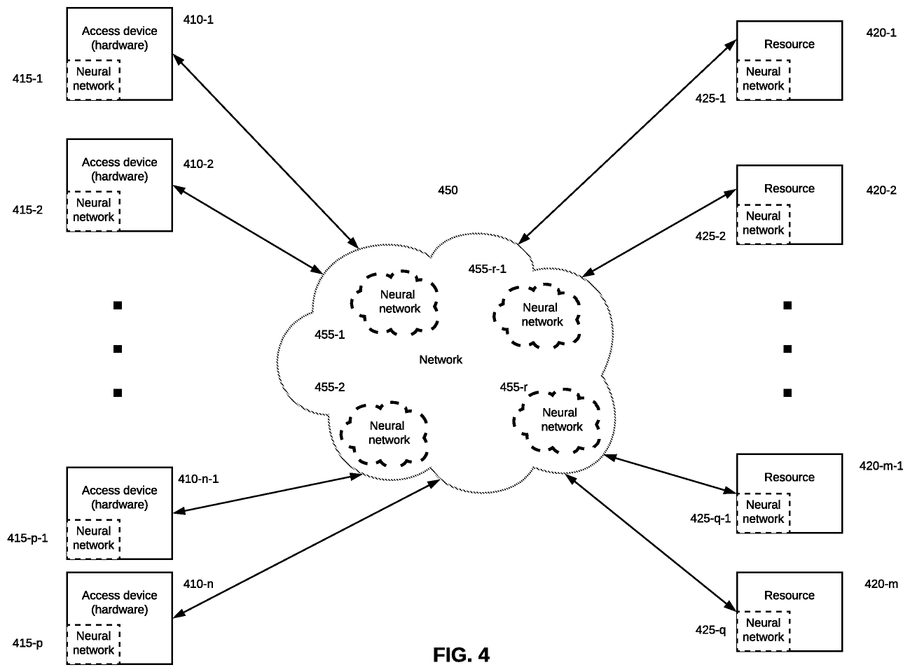

FIG. 4 is a high level diagram depicting a variety of ways in which access devices 410-1, 410-2, . . . , 410-n−1, 410-n can connect to resources 420-1, 420-2, . . . , 420-m−1, 420-m. A user can use one of the access devices 410-1, 410-2, . . . , 410-n−1, 410-n to connect to one of the resources 420-1, 420-2, . . . , 420-m−1, 420-m either directly, or through network 450. Dotted line boxes indicate neural networks, including elements 415-1 to 415-p within access devices 410-1 to 410-n; elements 425-1 to 425-q within resources 420-1 to 420-m; and elements 455-1 to 455-r within network 450, to show that a neural network providing a strong password to enable access to resources can reside either within access devices, or within resources, or within a network (i.e. in the cloud). Also, while not shown, there may be multiple neural networks in any of the access devices and/or any of the resources, to accommodate multiple users at a given access device or at a given resource, or a user using multiple access devices to access a given resource or resources.

In an embodiment, each of the access devices 410-1 to 410-n accepts one or more of the various categories of information, described earlier, that a user might input in order for a neural network to produce the strong password that enables the user to access a resource.

Embodiments of the invention as described herein have focused on neural networks. Other machine learning, artificial intelligence, or other deep learning technique may come to be known as a neural network. Or, types of neural networks may evolve. While not specifically enumerated here, it should be noted that any of these learning techniques may be relevant to implementation of aspects of the invention.

While embodiments of the invention have been described in detail, various modifications within the scope and spirit of the invention will be apparent to ordinarily skilled artisans. Consequently, the invention should be considered to be limited only by the following claims.

What is claimed is:

1. A password management method comprising:
generating a strong password;
providing a first item from one of a plurality of categories of information;
providing said strong password and said first item to a neural network on a first piece of hardware; and
training said neural network to recall said strong password from said first item.

2. A method according to claim 1, further comprising creating a user account with a username and password prior to generating said strong password.

3. A method according to claim 1, wherein said plurality of categories of information comprise a first category of information which comprises words, phrases, numbers, and/or pictures.

4. A method according to claim 3, wherein said plurality of categories of information further comprise a second category of information which comprises information related to said first piece of hardware.

5. A method according to claim 4, wherein said plurality of categories of information further comprise a third category of information which comprises biometric information of a user.

6. A method according to claim 2, wherein said first item is different from said username and password.

7. A method according to claim 1, further comprising:
providing a second item from a different one of said plurality of categories of information; and
providing said second item to said neural network on said first piece of hardware;
wherein said training comprises training said neural network to recall said strong password from said first and second items.

8. A method according to claim 7, further comprising:
providing a third item from a still different one of said plurality of categories of information; and
providing said third item to said neural network on said first piece of hardware;
wherein said training comprises training said neural network to recall said strong password from said first through third items.

9. A method according to claim 1, wherein generating said strong password comprises randomly selecting characters selected from the group consisting of numbers, symbols, upper case characters, and lower characters, and combining the randomly selected characters in a group of a predetermined length.

10. A method according to claim 1, further comprising accessing a secure resource after said neural network recalls said strong password.

11. A method according to claim 1, further comprising:
providing a further item, from one of said plurality of categories of information, and said strong password to said neural network via a second, different piece of hardware; and
re-training said neural network to recall said strong password from said further item.

12. A method according to claim 1, wherein said neural network is selected from the group consisting of a feed-forward neural network, a recurrent neural network, and a spiking neural network.

13. A method according to claim 1, wherein said neural network is a neural network with one or more hidden layers.

14. A method according to claim 1, wherein said neural network is located on said first piece of hardware.

15. A method according to claim 10, wherein the neural network is located at said secure resource.

16. A method according to claim 1, further comprising:
providing a further item, from one of said plurality of categories of information, and said strong password to a second, different neural network via a second, different piece of hardware; and
training said second neural network to recall said strong password from said further item.

17. A method according to claim 16, further comprising accessing a secure resource after said second neural network recalls said strong password.

18. A method according to claim 16, wherein said second neural network is located on said second piece of hardware.

19. A method according to claim 17, wherein said second neural network is located at said secure resource.
